(19) United States
(12) Patent Application Publication
(10) Pub. No.: US 2009/0217167 A1
(43) Pub. Date: Aug. 27, 2009

(54) Information processing apparatus and method and program

(75) Inventors: Atsushi Sugama, Kanagawa (JP); Masakazu Osawa, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/378,948

(22) Filed: Feb. 20, 2009

(30) Foreign Application Priority Data
Feb. 22, 2008 (JP) P2008-041219

(51) Int. Cl. G06F 3/14

(52) U.S. Cl. 715/727; 715/730

(57) ABSTRACT

Disclosed herein is an information processing apparatus for executing control such that one of image data and audio data is made subject to reproduction and the other data made subject to accompanying reproduction to reproduce both the subject to reproduction and the subject to accompanying reproduction, including a comparing section configured to unify a form of a feature of the subject to reproduction and a form of a feature of the subject to accompanying reproduction and make a comparison between these features; and a selecting section configured to select, on the basis of a result of comparison made by the comparing section, the subject to accompanying reproduction for the subject to reproduction from candidates of at least one subject to accompanying reproduction.

### CROSS REFERENCES TO RELATED APPLICATIONS

The present invention contains subject matter related to Japanese Patent Application JP 2008-041219 filed in the Japan Patent Office on Feb. 22, 2008, the entire contents of which being incorporated herein by reference.

### BACKGROUND OF THE INVENTION

1. Field of the Invention

The present invention relates to an information processing apparatus and method and a program and, more particularly, to an information processing apparatus and method and a program that are configured, if one of image and audio data is subject to reproduction and the other is subject to accompanying reproduction, to properly select the accompanying reproduction.

2. Description of the Related Art

The reproduction of image data in the manner of so-called slide show is in practice owing to the picture reproducing function of video recorders and application programs of personal computers, for example (refer to Japanese Patent Laid-open No. 2006-163966).

However, with related-art slide show reproduction technologies, the reproduction is accompanied by no BGM (Back Ground Music) at all or merely music randomly preselected from among prepared pieces of music. Therefore, there is no correlation between pictures being reproduced and background music, presenting a problem of the inability of providing no music suitable for pictures. In the reverse case, the same problem is presented, in which music is the main subject of reproduction and pictures are auxiliary subject of reproduction.

### SUMMARY OF THE INVENTION

Therefore, embodiments of the present invention addresses the above-identified and other problems associated with related-art methods and apparatuses and solves the addressed problems by providing an information processing apparatus and method and a program that are configured to allow, when one of music and picture is selected for main reproduction and the other for accompanying reproduction, the proper selection of the accompanying reproduction.

In carrying out the invention and according to one mode thereof, there is provided an information processing apparatus for executing control such that one of image data and audio data is made subject to reproduction and the other data made subject to accompanying reproduction to reproduce both the subject to reproduction and the subject to accompanying reproduction. This information processing apparatus has comparing means for unifying a form of a feature of the subject to reproduction and a form of a feature of the subject to accompanying reproduction and make a comparison between these features; and selecting means for selecting, on the basis of a result of comparison made by the comparing means, the subject to accompanying reproduction for the subject to reproduction from candidates of at least one subject to accompanying reproduction.

In the above-mentioned information processing apparatus, the comparing means unifies the forms of features by converting one of the feature of the subject to reproduction and the feature of a candidate of at least one subject to accompanying reproduction into the other.

The above-mentioned information processing apparatus further has analyzing means for analyzing the features of the image data and the audio data to create a database of results of analysis, wherein the comparing means references the features of the subject to reproduction and the at least one subject to accompanying reproduction from the database.

The above-mentioned information processing apparatus further has reproducing means for reproducing the subject to reproduction along with the subject to accompanying reproduction selected by the selecting means.

The above-mentioned information processing apparatus further has evaluating means for, on the basis of an evaluation by a user for a result of reproduction by the reproducing means, making a database of preference information of the user, wherein the comparing means uses the preference information accumulated in the database as a judgment element for a comparison between the feature of the subject to reproduction and the feature of the candidate of the at least one subject to accompanying reproduction.

In carrying out the invention and according to another mode thereof, there are provided an information processing method and a program for the above-mentioned information processing apparatus.

In the information processing apparatus and method and a program according to embodiments of the present invention, one of music and a picture is made subject to reproduction while the other is made subject to accompanying reproduction and the subject to reproduction is reproduced along with the subject to accompanying reproduction. To be more specific, the feature of the subject to reproduction and the feature of candidates of at least one subject to accompanying reproduction are unified for comparison. On the basis of a result of this comparison, the subject to accompanying reproduction for the subject to reproduction is selected from the candidates of one or more subjects to accompanying reproduction.

As described above and according to embodiments of the present invention, control can be executed such that one of music and a picture is made subject to reproduction while the other is made subject to accompanying reproduction to reproduce both the subjects. Especially, one or more subjects to accompanying reproduction can be selected appropriately.

### BRIEF DESCRIPTION OF THE DRAWINGS

Other aims and modes of the invention will become apparent from the following description of embodiments with reference to the accompanying drawings in which:

FIG. 1 is a block diagram illustrating an exemplary functional configuration of an information processing system practiced as one embodiment of the invention;

FIG. 2 is a flowchart indicative of an exemplary operation of the information processing system shown in FIG. 1;

FIG. 3 is a flowchart indicative of an exemplary operation of the information processing system shown in FIG. 1;

FIG. 4 is a flowchart indicative of an exemplary operation of the information processing system shown in FIG. 1;

FIG. 5 is a flowchart indicative of an exemplary operation of the information processing system shown in FIG. 1;

FIG. 6 is a flowchart indicative of an exemplary operation of the information processing system shown in FIG. 1;

FIG. 7 is a flowchart indicative of an exemplary operation of the information processing system shown in FIG. 1;

FIG. 8 is a flowchart indicative of an exemplary operation of the information processing system shown in FIG. 1; and

FIG. 9 is a block diagram illustrating an exemplary configuration of a personal computer that functions as an information processing apparatus practiced as another embodiment of the invention.

### DETAILED DESCRIPTION OF THE PREFERRED EMBODIMENTS

This invention will be described in further detail by way of embodiments thereof with reference to the accompanying drawings.

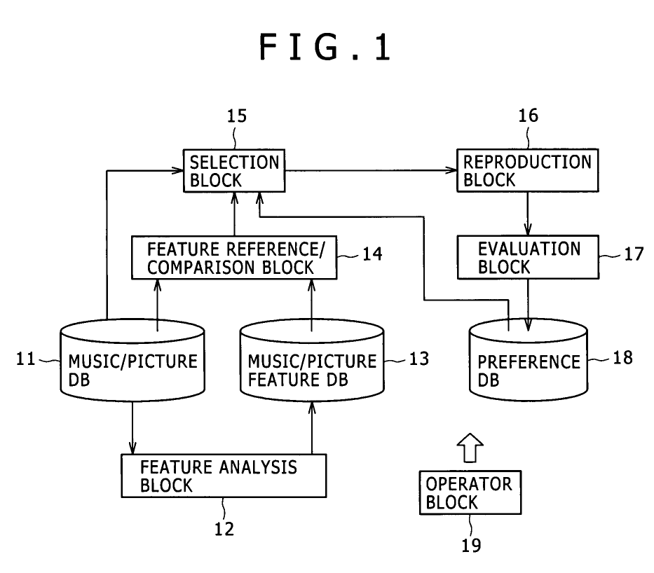

Now, referring to FIG. 1, there is shown an exemplary functional configuration of an information processing system practiced as one embodiment of the invention.

A system herein denotes an entire apparatus composed of two or more devices and processing blocks. Namely, the information processing system shown in FIG. 1 may be configured as one unit or as two or more units.

The information processing system shown in FIG. 1 has a music/picture DB (Data Base) 11, a feature analysis block 12, a music/picture feature DB 13, a feature reference/comparison block 14, a selection block 15, a reproduction block 16, an evaluation block 17, a preference DB 18, and an operator block 19.

The music/picture DB 11 stores one or more pieces of music data and one or more pieces of picture data.

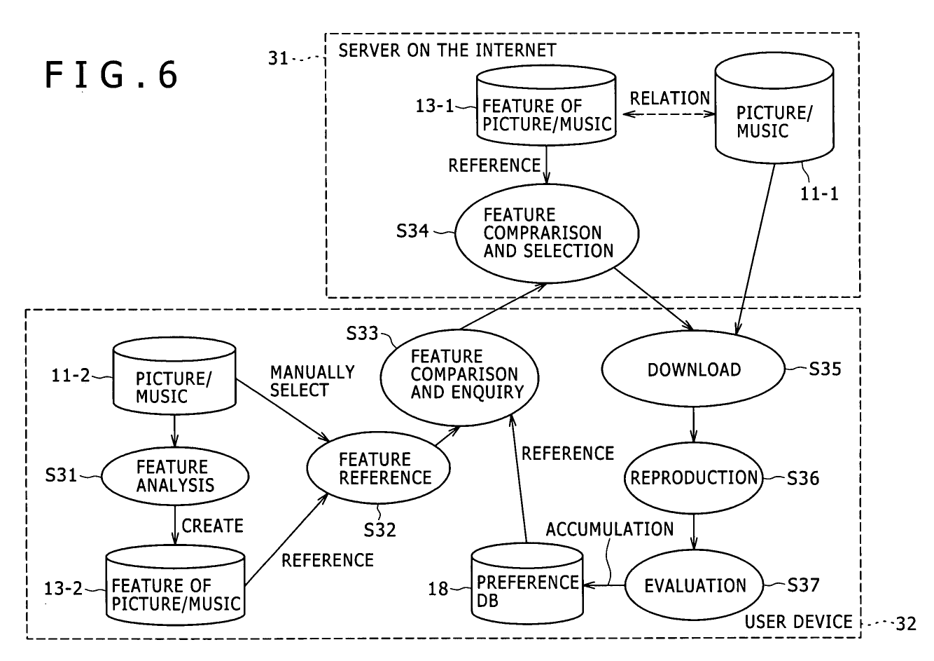

It should be noted that the music/picture DB 11 may be built on a same recording media or two or more recording media. For example, the music/picture DB 11 may be configured by a first recording media to which merely music is recorded and a second recording media to which merely pictures are recorded. Also, the music/picture DB 11 may be configured by a first recording media installed on user device (a user device 32 shown in FIG. 6 to be described later, for example) and a second recording media installed on an Internet server (a server 31 shown in FIG. 6 to be described later, for example). In addition, the music/picture DB 11 may be configured on separate recording media from other databases to be described later or on a same recording media. The description in this paragraph also applies to other databases.

The feature analysis block 12 analyzes the feature of each predetermined picture stored in the music/picture DB 11 and stores the results of the analysis into the music/picture feature DB 13. The features of each picture to be analyzed are not restricted; for example, the features may include scenery, contrast, tone, time, season, human facial expression, and so on. It should be noted however that, in the present embodiment of the invention, the feature analysis block 12 analyzes, from each picture, human facial expression (or emotions) and the brightness of an entire picture and digitalizes the two analysis results, storing the resultant digital data into the music/picture feature DB 13.

Further, the feature analysis block 12 analyzes the feature of predetermined music stored in the music/picture DB 11 and stores the results of the analysis into the music/picture feature DB 13. The feature of music is not especially limited. However, in the present embodiment, the feature analysis block 12 analyzes two features of tempo and tune from the music data and digitizes the two analysis results, storing the resultant digital data into the music/picture feature DB 13.

It should be noted that the feature analysis block 12 may be configured by hardware or software or a combination thereof. In the case of the present embodiment, the feature analysis block 12 is configured to have software that can analyze both music and picture, namely, so-called analysis application software.

Thus, the feature of a picture is stored in the music/picture feature DB 13 as related with the picture (or the data stored in the music/picture DB 11) and the feature of a piece of music is stored in the music/picture feature DB 13 as related with the piece of music (or the data stored in the music/picture DB 11).

The feature reference/comparison block 14 references, from the music/picture feature DB 13, the feature of a picture subject to reproduction and the feature of a music candidate to be reproduced at the same time as this picture. A music candidate may sufficiently be one or more pieces of music of all pieces of music stored in the music/picture feature DB 13. However, in the present embodiment, all pieces of music stored in the music/picture feature DB 13 are subject to music candidates.

The feature reference/comparison block 14 makes a comparison between the feature of a picture (a picture to be used for slide show reproduction, for example) subject to reproduction and the feature of a candidate of music (a piece of music to be used as BGM, for example). However, the feature of a picture subject to reproduction and the feature of a music candidate may not be directly compared with each other. Therefore, the feature reference/comparison block 14 converts one of the features into the other before making the comparison. A comparison result obtained by the feature reference/comparison block 14 is supplied to the selection block 15.

Also, the feature reference/comparison block 14 makes a comparison between the feature of music subject to reproduction (a piece of music desired by the user for reproduction not as BGM but for listening by the user, for example) and the feature of a picture candidate (a background picture for example) that accompanies the music. In this case, too, the feature reference/comparison block 14 converts one of the features into the other before making the comparison. A comparison result obtained by the feature reference/comparison block 14 is supplied to the selection block 15.

It should be noted that, in what follows, a picture or a piece of music subject to reproduction is called content subject to reproduction and a piece of music or a picture to be reproduced in accompaniment with the content subject to reproduction is called background content.

The selection block 15 gets content subject to reproduction from the music/picture DB 11 and supplies the obtained content subject to reproduction to the reproduction block 16. In addition, the selection block 15 selects one or more pieces of background content on the basis of a comparison result obtained by the feature reference/comparison block 14. The selection block 15 gets the selected background content from the music/picture DB 11 and supplies the obtained background content to the reproduction block 16.

It should be noted that the feature reference/comparison block 14 and the selection block 15 may be configured by hardware or software or a combination thereof. In the present embodiment, the feature reference/comparison block 14 and the selection block 15 are configured to have each predetermined application software.

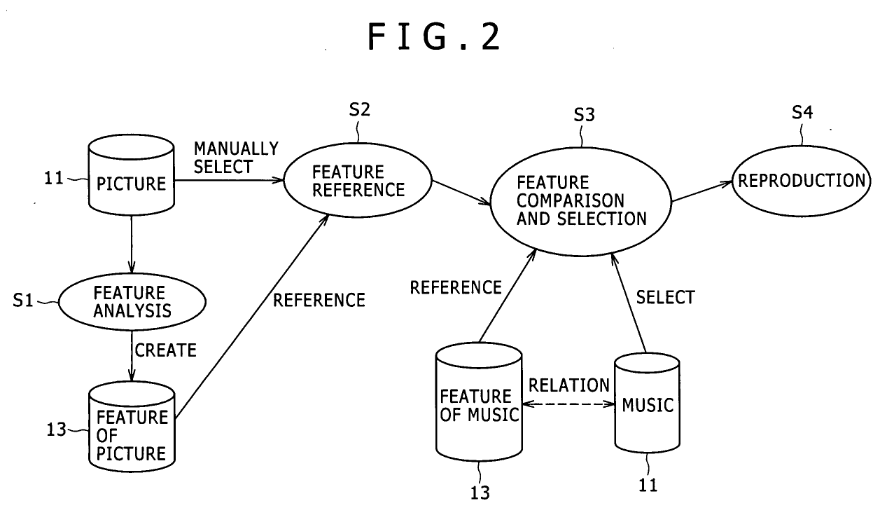

Examples of the processing to be executed by the feature reference/comparison block 14 and the selection block 15 will be described later with reference to FIGS. 2 and on.

The reproduction block 16 reproduces the content subject to reproduction supplied from the selection block 15 along with the background content supplied from the selection block 15.

It is sufficient for the reproduction block 16 to have a function of converting content subject to reproduction and background content from data into video data or audio data and outputting the converted video data or audio data. Namely, the reproduction block 16 may be configured by a display monitor for example for displaying video data or a loudspeaker for example for sounding audio data and hardware or software or a combination thereof that can convert video data and audio data into the form that can be outputted from a display for example and a loudspeaker for example, respectively. It should be noted that, as seen from the definition of system described above, the reproduction block 16 need not be especially configured in one unit. Namely, a display monitor for example, a loudspeaker for example and hardware or software or a combination thereof that can convert the form of content into the form of output of the display monitor for example or the loudspeaker for example need not be especially installed on a single unit.

The evaluation block 17 evaluates the reproduction result obtained by the reproduction block 16 from the viewpoint of user preference and stores an evaluation result into the preference DB 18 as user preference information. As will be described later, this preference information is also used for the processing of selecting background content by the selection block 15.

It should be noted that the evaluation block 17 may be configured by hardware or software or a combination thereof. In the present embodiment, the evaluation block 17 is configured to have predetermined application software, for example.

The operator block 19 accepts an operation done by the user and transmits a command corresponding to the operation to corresponding functional blocks (the feature analysis block 12 and so on) described above. Namely, the above-mentioned functional blocks can also execute the processing in accordance with commands received from the operator block 19. It should be noted that the types of operations done through the operator block 19 will be described later with reference to FIG. 2 and on.

The following describes the types of operations to be executed by the information processing system shown in FIG. 1 with reference to the flowcharts shown in FIGS. 2 through 9.

In the flowcharts shown in FIGS. 2 through 9, each elliptic block attached with sign S is indicative of a processing. Various DBs are also shown for the ease of understanding. It should be noted that the text shown in each DB is indicative of the subject of processing. For example, referring to FIG. 2, there are DBs having reference numeral 11 in the upper left side and the lower right side. These two DBs are music/picture DBs 11. It should be noted that “PICTURE” is written in the upper left music/picture DB 11, so that the subject of processing is pictures; “MUSIC” is written in the lower right music/picture DB 11, so that the subject of processing is music. Each solid-line arrow is indicative of a flow of information. A dashed-line arrow is indicative that there is a relation between content (picture or music) and a feature thereof.

FIG. 2 is the flowchart indicative of an exemplary operation of the information processing system when the content subject to reproduction is a picture and the background content is music, namely, the BGM suited to the slide show reproduction of a picture is automatically selected, for example.

In step S1, the feature analysis block 12 analyzes the feature of the picture to be processed and stores an analysis result into the music/picture feature DB 13.

When a predetermined picture is selected by the user through the operator block 19, the feature reference/comparison block 14 references the music/picture feature DB 13 to extract the feature of the selected predetermined picture in step S2.

In step S3, the feature reference/comparison block 14 makes a comparison between the feature of the referenced predetermined picture and a feature of each music candidate. The selection block 15 selects, as BGM, a piece of music found related with the feature of the predetermined picture.

To be more specific, in this example, one or more music candidates are stored in the music/picture DB 11 beforehand and the features of these music candidates are stored in the music/picture feature DB 13 as related with corresponding pieces of music. Therefore, the feature reference/comparison block 14 extracts the features of one or more music candidates by referencing the music/picture feature DB 13. Next, the feature reference/comparison block 14 makes a comparison between the feature of the reference predetermined picture and the features of one or more music candidates and supplies a comparison result to the selection block 15. On the basis of the supplied comparison result, the selection block 15 determines a piece of music that is related with the predetermined picture. Then, the selection block 15 selects and extracts the related piece of music from the music/picture DB 11 as BGM and supplies the extracted piece of music to the reproduction block 16. At the same time, the selection block 15 provides the predetermined picture to the reproduction block 16.

Then, in step S4, the reproduction block 16 executes slide show reproduction including the predetermined picture and, at the same time, reproduces the piece of music (related with the predetermined picture) automatically selected by the processing in step S3.

The following describes in detail a feature comparing processing of step S3, namely, the processing of making a comparison between the feature of picture and the feature of music.

As described above, in the present embodiment, two types of features of picture are used; the human facial expression and the brightness of an entire picture. In the feature analysis processing in step S1, the features of these two types are digitized to obtain a facial expression value and a brightness value. On the other hand, in the present embodiment, two types of music features are used; tempo and tune. As a result of the digitization of these two types of music features for each piece of music, a tempo value and a tune value are prepared.

Obviously, in this case, it is difficult to make a comparison between the feature of picture and the feature of music (candidate) in the form as they are. Therefore, in the present embodiment, the feature reference/comparison block 14 converts the form of the feature of picture into the form of the feature of music as follows, for example.

Namely, in order to get a tempo value matching the selected predetermined picture, the feature reference/comparison block 14 substitutes the features (facial expression value, brightness value) into equation (1) below.

Tempo value=a₁₁×facial expression value+a₁₂×brightness value+b₁ (1)

Likewise, in order to get a tune value matching the selected predetermined picture, the feature reference/comparison block 14 substitutes the features (facial expression value, brightness value) of that predetermined picture into equation (2) below.

Tune value=a₂₁×facial expression value+a₂₂×brightness value+b₂ (2)

It should be noted that a₁₁, a₁₂, a₂₁, a₂₂, b₁ and b₂ in equations (1) and (2) above are indicative of predetermined coefficients.

Namely, the feature of a predetermined picture was converted from the form (facial expression value, brightness value) into the form (tempo value, tune value) of the feature of music.

Consequently, by use of an appropriate comparison technique, the feature reference/comparison block 14 gets ready for making comparison between the feature of a predetermined picture and the features of one or more music candidates. For example, use of a comparison technique capable of computing similarity allows the selection block 15 to determine music candidates having similarities higher than a certain level to be the music associated with a predetermined picture.

It should be noted that, in the present embodiment, two types of picture features (facial expression value, brightness value) are used and two types of music features (tempo value, tune value) are used as described above. However, the number of types is not limited to these two. For example, the number of types may be three or more. In this case, in order to convert the feature of a predetermined picture from a form (facial expression value, brightness value, . . . ) into a form (tempo value, tune value, . . . ) of the feature of music, equation (3) below may be used, for example.

$$( \begin{matrix}tempo value \\ tune value \\ ⋮\end{matrix} ) = ( \begin{matrix}{a}_{11} & {a}_{12} & … \\ {a}_{21} & {a}_{22} & … \\ ⋮ & ⋮ & ⋰\end{matrix} ) \times ( \begin{matrix}facial \\ expression value \\ brightness value \\ ⋮\end{matrix} ) + ( \begin{matrix}{b}_{1} \\ {b}_{2} \\ ⋮\end{matrix} ) . \qquad ( 3 )$$

It should be noted that, in the slide show reproduction of pictures, two or more pictures are sequentially reproduced. In this case, every time pictures subject to reproduction change, a piece of music related with each picture can be sounded as BGM. However, if two or more pictures are related with each other, if a character remains the same, for example, two or more pictures may be regarded as one group to select a piece of music suited to that group as BGM.

For example, it is assumed that features that are time-dependent changes be recorded to the music/picture feature DB 13 in addition to the features of a piece of music as a whole. In this case, when a picture group is reproduced in a slide show manner, the pictures change with time, so that this change of pictures can be understood as the change of picture features with time. Therefore, the feature reference/comparison block 14 can compare the information itself indicative of this change or the information obtained by appropriately manipulating that information, being indicative of the feature of the picture group with the feature that is the time-dependent change of the music. As a result, the selection block 15 can select a piece of music suited to the picture change. Namely, this setup allows the selection of a piece of music that matches the feature of the group of pictures for slide show reproduction.

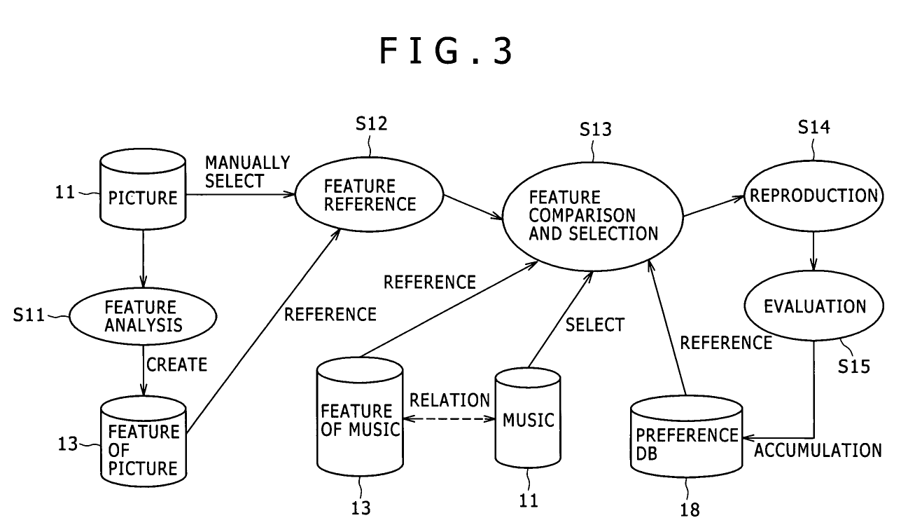

FIG. 3 shows a flowchart indicative of an exemplary operation to be executed by the information processing system in the automatic selection of the BGM that is suited to the slide show reproduction of pictures, for example, when the content subject to reproduction is pictures and the background content is music.

To be more specific, the flowchart shown in FIG. 3 is the same as the flowchart shown in FIG. 2 in that the BGM suited to the slide show reproduction of pictures is automatically selected. However, the example shown in FIG. 3 differs from the example shown in FIG. 2 in three points. Namely, the first difference is that slide show reproduction is evaluated by the user to make a database of user preference. The second difference is that the preference database (the preference DB 18 shown in FIG. 1) thus created stores, as user preference information, the information indicative of user's preferential inclination for the features of picture and music having particular features and the information indicative of the features of picture and the music features preferred by the user for these picture features. The third difference is that this preference information is used for subsequent music selection. These three points of the example shown in FIG. 3 allows the selection of music to be more suited to user preference.

Steps S11, S12, and S14 shown in FIG. 3 are substantially the same as steps S1, S2, and S4 shown in FIG. 2. Therefore, the following describes the processes to be executed in steps S15 and S13.

In step S15, the evaluation block 17 evaluates picture slide show reproduction by the reproduction block 16 from the viewpoint of user preference and stores an obtained evaluation result into the preference DB 18 as user preference information.

It should be noted that the slide show reproduction evaluating method itself is not limited. For example, in the present embodiment, it is assumed that the following evaluation method be used. Namely, if the user determines that the automatically selected music (BGM) is not suitable for a reproduced picture, the user operates the operator block 19 to select a piece of music that the user thinks suitable for the reproduced picture. It is assumed that the present embodiment use an evaluation method that, receiving this selective operation, the evaluation block 17 receives this selective operation and evaluates slide show reproduction by obtaining the values of the features of the reproduced pictures and the value of the feature of the music selected by this operation. Namely, the information in which the values of the features of the reproduced pictures and the value of the feature of the music selected by this operation are related with each other is accumulated in the preference DB 18 as user preference information.

Consequently, the following processing is enabled as the processing of step S13.

To be more specific, letting the user himself evaluate the slide show reproduction thereafter allows the execution of processing in which the difference between the feature value of music (selected as BGM) computed from the picture feature and the feature value of music to be obtained by the user is minimized as the processing of step S13 to be executed later. This processing is expressed in the following equation.

Namely, equation (1) above may be transformed into equation (4) below.

2×tempo value/2=(a₁₁×facial expression value+b₁l)+(a₁₂×brightness value+b₁₂) (4)

Equation (4) above may be resolved into equation (5) and equation (6) below.

Tempo value/2=a₁₁×facial expression value+b₁₁ (5)

Tempo value/2=a₁₂×brightness value+b₁₂ (6)

Now, an approximate expression of equation (1) above is obtained by use of the least square method from the response of the tempo value (of the music selected by the user) for the facial expression value (or the reproduced picture) among the pieces of preference information accumulated by the evaluation of slide show reproduction, thereby introducing coefficients for getting close to the response considered by the user. Let the coefficients thus introduced be a₁₁, a₁₂, b₁, and b₂, then an approximate expression of equation (1) is expressed as equation (7) below.

Tempo value=a′₁₁×facial expression value+a′₁₂×brightness value+b′₁₁+b′₁₂ (7)

Likewise, an approximate expression of equation (2) above is expressed as equation (8) below.

Tune value=a′₂₁×facial expression value+a′₂₂×brightness value+b′₂₁+b′₂₂ ( 8)

It should be noted that, in the present embodiment, the two types of picture features (facial expression value, brightness value) are used and the two types of music features (tempo value, tune value) are used as described above. However, the number of types is not limited to these two. For example, the number of types may be three or more. In this case, in order to convert the feature of a predetermined picture from a form (facial expression value, brightness value, . . . ) into a form (tempo value, tune value, . . . ) of the feature of music, equation (3) above may be used. Therefore, if there are three or more types, an approximate expression of this equation (3) may be used.

To be more specific, let the first element of a music feature value be y₁, j-th element of a picture feature be xⱼ, and the number of elements of the picture feature value be m, then a relation as shown in FIG. (9) is obtained.

$$m \times ( \frac{{y}_{1}}{m} ) = {\sum }_{k = 1}^{m} ( {a}_{1 k} {x}_{k} + {b}_{1 k} ) \qquad ( 9 )$$

Equation (9) above can be resolved into equation (10) below.

$$( \frac{{y}_{1}}{m} ) = {a}_{11} {x}_{1} + {b}_{11} \\ ( \frac{{y}_{1}}{m} ) = {a}_{12} {x}_{2} + {b}_{12} \\ … \\ ( \frac{{y}_{1}}{m} ) = {a}_{1 m} {x}_{m} + {b}_{1 m} \qquad ( 10 )$$

Namely, the equation resolved for h-th element yₖ of the music feature value is expressed as equation (11) below.

$$m \times ( \frac{{y}_{h}}{m} ) = {\sum }_{k = 1}^{m} ( {a}_{hk} {x}_{k} + {b}_{hk} ) \qquad ( 11 )$$

Therefore, response yₕ/m included in h-th element yₕ of the music feature value from j-th element xⱼ of the picture feature value is expressed as equation (12) below.

$$( \frac{{y}_{h}}{m} ) = {a}_{hj} {x}_{j} + {b}_{hj} \qquad ( 12 )$$

Hence, aₕⱼ′, bₕⱼ′ can be determined by obtaining an approximate expression as shown in equation (13) below from user preference information values stored in the preference DB 18.

$$( \begin{matrix}tempo value \\ tune value \\ ⋮\end{matrix} ) = ( \begin{matrix}{a ’}_{11} & {a ’}_{12} & … \\ {a ’}_{21} & {a ’}_{22} & … \\ ⋮ & ⋮ & ⋰\end{matrix} ) \times ( \begin{matrix}facial \\ expression value \\ brightness value \\ ⋮\end{matrix} ) + ( \begin{matrix}{\sum }_{k = 1}^{m} {b}_{1 k}^{’} \\ {\sum }_{k = 1}^{m} {b}_{2 k}^{’} \\ ⋮\end{matrix} ) . \qquad ( 13 )$$

Thus, by use of a coefficient in the approximate expressions (7) and (8) or approximate expression (13), which is a new coefficient derived by use of the preference DB 18, the feature reference/comparison block 14 can convert the form of a predetermined picture feature into the form of a music feature. Then, the feature reference/comparison block 14 can make a comparison between the feature of a predetermined picture of which form has been converted as described above and the feature of one or more music candidates. By use of a result of this comparison, the selection block 15 can select the music more suited to user preference as BGM.

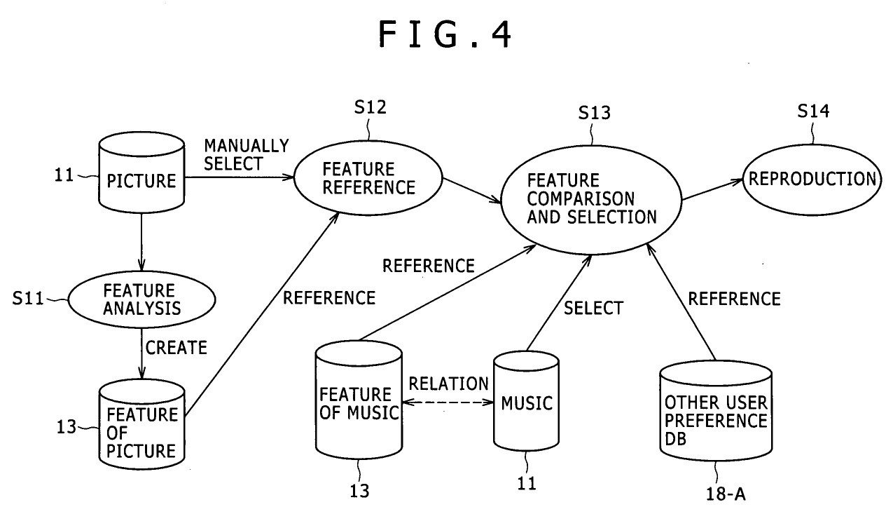

The preference DB 18 is not a database that directly connect pictures with music, but a database in which the picture and music features are connected to user preference inclinations. Therefore, in the comparison processing of step S13, not the preference DB 18 of the user himself but a preference DB 18-A of another user may be used as shown in FIG. 4. Consequently, the automatic selection of music may be matched with the preference of another user.

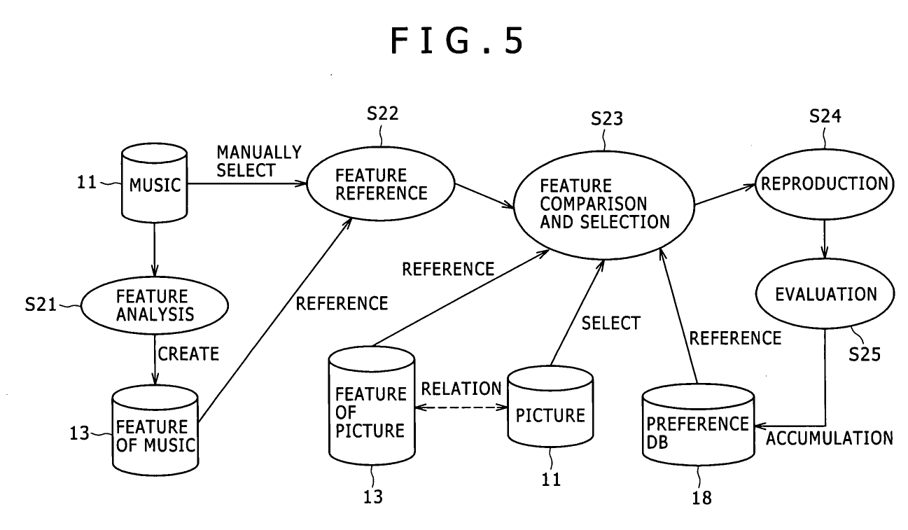

Referring to FIG. 5, there is shown a flowchart indicative of an exemplary operation of the information processing system that is executed when the content subject to reproduction is music and background content is a picture, namely, when automatically selecting a background image suited to the reproduction of music. In other words, FIG. 5 shows an exemplary operation of the information processing system that is executed in the slide show reproduction of pictures related with the music to be reproduced.

In step S21, the feature analysis block 12 analyzes the feature of music and stores a result of the analysis into the music/picture feature DB 13.

When a predetermined piece of music is selected by the user through the operator block 19, the feature reference/comparison block 14 references the music/picture feature DB 13 to extract the feature of this predetermined piece of music in step S22.

In step S23, the feature reference/comparison block 14 makes a comparison between the referenced feature of the predetermined piece of music and the feature of each prepared picture. The selection block 15 selects a related picture as a background image. It should be noted that, as will be described later, the user preference information stored in the preference DB 18 can also be used in the processing of step S23.

In step S24, the reproduction block 16 reproduces the predetermined piece of music and, at the same time, reproduces the pictures (related with the predetermined piece of music), in a slide show manner, automatically selected in the processing of step S23, as background images.

In step S25, the evaluation block 17 evaluates the reproduction of music executed by the reproduction block 16 from the viewpoint of user preference and stores a result of this evaluation into the preference DB 18 as the user preference information.

The following describes details of the feature comparison processing of step S23, namely, the processing of making a comparison between the feature of music and the features of picture candidates.

First, comparison processing in which the user preference information stored in the preference DB 18 is not used will be described with reference to FIG. 2.

As described above, in the present embodiment, two types of music features, music tempo and tune, are used for music features. In the feature analysis processing of step S21, these two types of features are digitized to obtain (tempo value, tune value). On the other hand, in the present embodiment, two picture feature types of human facial expressions (emotions) and brightness of entire picture are used for picture features. As a result of the digitization of these two feature types for each of one or more pictures, (facial expression value, tune value) are prepared.

Obviously, in this case, it is difficult to make a comparison between the feature of music and the feature of picture (candidate) in the form as they are. Therefore, in the present embodiment, the feature reference/comparison block 14 converts the form of music feature into the form picture feature as follows.

Namely, in order to obtain (facial expression value) matching the selected predetermined piece of music, the feature reference/comparison block 14 substitutes the features (tempo value, tune value) of the predetermined piece of music into equation (14) below.

Facial expression value=c₁₁×tempo value+c₁₂×tune value+d₁ (14)

Likewise, in order to get (brightness value) matching the selected predetermined piece of music, the feature reference/comparison block 14 substitutes the features (tempo value, tune value) of that predetermined piece of music into equation (15) below.

Brightness value=c₂₁×tempo value+c₂₂×tune value+d₂ (15)

It should be noted that c₁₁, c₁₂, c₂₁, c₂₂, d₁ and d₂ in equations (14) and (15) above are indicative of predetermined coefficients.

Namely, the feature of a predetermined piece of music was converted from the form (tempo value, tune value) into the form (facial expression value, brightness value) of the feature of picture.

Consequently, by use of an appropriate comparison technique, the feature reference/comparison block 14 gets ready for making comparison between the feature of a predetermined piece of music and the features of one or more music candidates. For example, use of a comparison technique capable of computing similarity allows the selection block 15 to determine picture candidates having similarities higher than a certain level to be the picture associated with a predetermined piece of music.

It should be noted that, in the present embodiment, two types of picture features (facial expression value, brightness value) are used and two types of music features (tempo value, tune value) are used as described above. However, the number of types is not limited to these two. For example, the number of types may be three or more. In this case, in order to convert the feature of a predetermined piece of music from a form (tempo value, tune value, . . . ) into a form (facial expression value, brightness value, . . . ) of the feature of picture, equation (16) below may be used, for example.

$$( \begin{matrix}facial \\ expression \\ value \\ brightness value \\ ⋮\end{matrix} ) = ( \begin{matrix}{c}_{11} & {c}_{12} & … \\ {c}_{21} & {c}_{22} & … \\ ⋮ & ⋮ & ⋰\end{matrix} ) \times ( \begin{matrix}tempo value \\ tune value \\ ⋮\end{matrix} ) + ( \begin{matrix}{d}_{1} \\ {d}_{2} \\ ⋮\end{matrix} ) . \qquad ( 16 )$$

The following describes comparison processing in which the user preference information stored in the preference DB 18 is used, with reference to FIG. 3.

It is assumed that the evaluation method used in the evaluation processing of step S25 be substantially the same as the evaluation method used in the evaluation processing of step S15 shown in FIG. 3. Namely, in this example, the information in which the feature values of the reproduced music is related with the feature values of the pictures selected by the user as optimum is accumulated in the preference DB 18 as user preference information.

Consequently, the following processing becomes practicable as the processing of step S23.

To be more specific, the processing becomes practicable in which letting the user himself evaluate the reproduction of music thereafter minimizes the difference between the picture feature value computed from the feature of music and the feature value of the piece of music desired by the user. Namely, letting the user make the evaluation after reproduction allows the execution of substantially the same processing as described by use of equations (4) through (13) above so as to minimize the difference between the feature of the picture (selected as a background image) compute from the value of music feature and the value of the feature of music desired by the user.

For example, cₕⱼ′, dₕⱼ′ can be determined by obtaining an approximate expression as indicated by equation (17) below from the user's each piece of preference information stored in the preference DB 18 as an approximate expression of equation (16).

$$( \begin{matrix}facial expression \\ value \\ brightness value \\ ⋮\end{matrix} ) = ( \begin{matrix}{c ’}_{11} & {c ’}_{12} & … \\ {c ’}_{21} & {c ’}_{22} & … \\ ⋮ & ⋮ & ⋰\end{matrix} ) \times ( \begin{matrix}tempo value \\ tune value \\ ⋮\end{matrix} ) + ( \begin{matrix}{\sum }_{k = 1}^{n} {d}_{1 k}^{’} \\ {\sum }_{k = 1}^{n} {d}_{2 k}^{’} \\ ⋮\end{matrix} ) . \qquad ( 17 )$$

Thus, by use of a coefficient in the approximate expressions (17) and so on, which is a new coefficient derived by use of the preference DB 18, the feature reference/comparison block 14 can convert the form of a predetermined music feature into the form of a picture feature. Then, the feature reference/comparison block 14 can make a comparison between the feature of a predetermined piece of music of which form has been converted as described above and the feature of one or more picture candidates. By use of a result of this comparison, the selection block 15 can select the picture more suited to user preference as a background image.

It should be noted that, although not shown, in the same manner as shown in FIG. 4, the comparison processing of step S23 can use the preference DB 18-A of another user rather than the preference information of the user himself. Consequently, the automatic selection of pictures can be matched with the preference of another user.

As described above, the information processing system shown in FIG. 1 can be configured by two or more apparatuses. For example, FIG. 6 is a flowchart indicative of an exemplary operation of an information processing system configured by an Internet server 31 and a user device 32.

It should be noted, as shown in FIG. 6, of the music/picture DBs 11, a database arranged on the side of the Internet server 31 is called a music/picture DB 11-1 and a database arranged on the side of the user device 32 is called a music/picture DB 11-2. In the same manner, with other databases and functional blocks shown in FIG. 1, those arranged on the side of the Internet server 31 are identified by “1” following hyphen “-” and those arranged on the side of the user device 32 are identified by “2” following hyphen “-.”

The Internet server 31 manages prepared pictures and music and the features thereof and, in response to enquiries from the user device 32 on the basis of picture/music features and preference information, selects requested materials.

In this case, in step S31, a feature analysis block 12-2 on the side of the user device 32 analyzes the feature of picture and/or music and stores a result of this analysis into the music/picture feature DB 13-2.

When a predetermined picture and/or a predetermined piece of music is selected by the user through an operator block 19-2, a feature reference/comparison block 14-2 on the side of the user device 32 references a music/picture feature DB 13-2 to extract the feature of the predetermined picture and/or the predetermined piece of music in step S32.

In step S33, a feature reference/comparison block 14-2 on the side of the user device 32 provides the feature of the referenced predetermined picture and/or predetermined piece of music and the preference information obtained from a preference DB 18-2 as desired to the Internet server 31, thereby transmitting the associated materials to the Internet server 31.

In step S34, a selection block 15-1 on the side of the Internet server 31 makes a comparison between the feature of the predetermined picture and/or predetermined piece of music and features of prepared music and/or picture candidates to select a related piece of music as BGM and a related picture as a background image. The piece of music and the picture selected as BGM and a background image are transferred from the Internet server 31 to the user device 32.

In step S35, a reproduction block 16-1 on the side of the user device 32 downloads the transferred music and/or picture. It should be noted that the material (music and/or picture) to be downloaded at this moment can also be selected by the user. It is assumed that the predetermined picture and/or the predetermined piece of music have already been provided to a reproduction block 16-2 as internal processing of the user device 32.

In step S36, the reproduction block 16-2 on the side of the user device 32 executes slide show reproduction including the predetermined picture and, at the same time, reproduces the music (related with the predetermined picture) downloaded in the processing of step S35. Alternatively, the reproduction block 16-2 on the side of the user device 32 reproduces the predetermined piece of music and, at the same time, executes slide show reproduction of the pictures (related with the predetermined piece of music) downloaded in the processing of step S35 as a background image.

It should be noted that the Internet server 31 can also execute the processing of selecting the music that an advertiser wants to advertise or a picture for advertisement image as the selection processing in step S34 shown in FIG. 6. In this case, the BGM and background image to be reproduced along with a predetermined picture and a predetermined piece of music are the BGM and background image associated with the advertisement. Namely, in this form, it is practicable to distribute advertisement to the user.

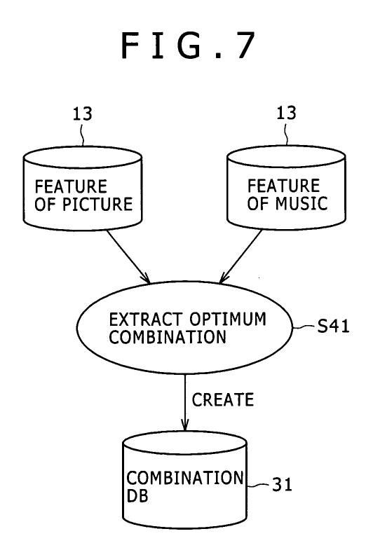

FIG. 7 shows a flowchart indicative of an exemplary operation of the information processing system, in which a combination database 31 is created.

The combination DB 31 herein denotes a database on which the information about optimum combinations of picture and music is accumulated.

Namely, when the processing in accordance with the flowchart shown in FIG. 7 is executed, the combination DB 31 is built on the information processing system shown in FIG. 1.

To be more specific, in step S41, the feature reference/comparison block 14 references the music/picture feature DB 13 to extract an optimum combination of picture and music.

It should be noted that there is no limitation to the combination extraction method itself. For example, a method can be employed in which the form of picture feature can be converted into the form of music feature by use of equations (3) and so on described above to make a comparison between the feature of picture and the features of one or more pieces of music, thereby extracting an optimum combination of picture and music. Also, for example, a method can be employed in which the form of music feature can be converted into the form of picture feature by use of equations (16) and so on described above to make a comparison between the music feature and the features of one or more pictures, thereby extracting an optimum combination of picture and music.

When the processing of step S41 has been executed, the pictures and the music to be combined as a result of this processing and the features thereof are related with each other to be stored in the combination DB 31.

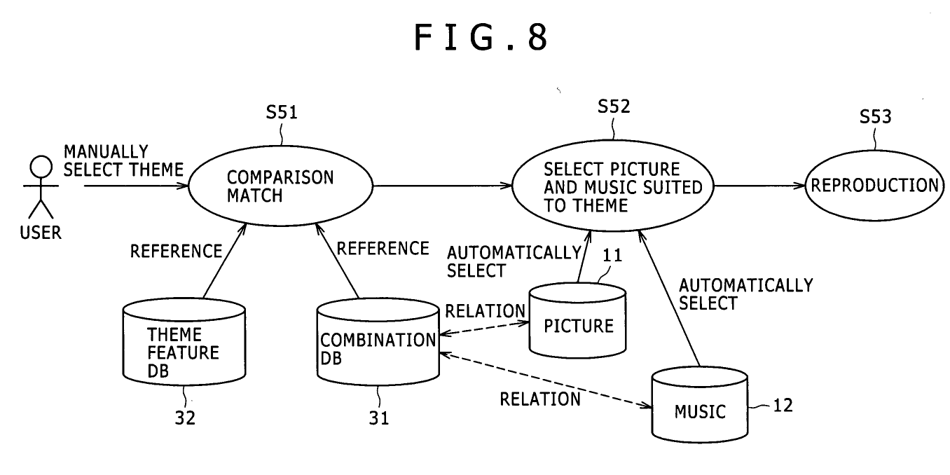

FIG. 8 is a flowchart indicative of one example of processing based on the combination DB 31, of the processing to be executed by the information processing system shown in FIG. 1, in which a sequence of processing operations from the automatic selection of pictures and music suited to a theme (keyword) entered by the user to the reproduction of these pictures and music is executed, for example.

It is assumed that a theme feature DB 32 as shown in FIG. 8 be built on the information processing system. It is also assumed that the features of the pictures and the music suited to a theme (keyword) be recorded to the theme feature DB 32. In other words, the theme feature DB 32 is configured independently of the music/picture feature DB 13 in FIG. 8; however, the theme feature DB 32 need not especially be configured in an independent manner. Namely, the theme feature DB 32 can also be configured in the music/picture feature DB 13.

When the user selects a theme (keyword) of slide show through the operator block 19, the feature reference/comparison block 14 makes a comparison between the features of pictures and music recorded to the theme feature DB 32 and the combination DB 31 to extract a combination of pictures and music suited to the theme in step S51, for example. A result of this extraction is transmitted to the selection block 15.

In step S52, the selection block 15 selects, from the music/picture DB 11, the pictures and music included in that combination, namely, the pictures and music suited to the theme, supplying the selected pictures and music to the reproduction block 16.

In step S53, the reproduction block 16 executes slide show reproduction by combining the selected pictures and music.

The application of the embodiments of the present invention described so far provides the following effects.

Analysis of the features of pictures and the creation of a database of the analysis results allow the automatic selection of the music suited to pictures.

Analysis of the features of music and the creation of a database of analysis results allow the automatic selection of the pictures suited to music.

Letting the user make evaluation at the time of slide show reproduction and the creation of a database of the evaluation results allow the selection of pictures and the selection of music in a more suitable manner to user preference.

Letting the user hear and view music samples and picture samples at the time of slide show reproduction by use of the function of downloading music and pictures on the basis of a user preference database allows the user to download preferences. Further, because such user operations can be charged, the embodiments of the present invention can be used as a new business model.

Automatization of database creation and picture and music selection can mitigate the load of the user in the management of pictures and music.

The function of selecting pictures and music can be arranged on the Internet on the basis of user preference information and picture and music feature information, so that the embodiments of the present invention can be applied to the field of advertisement distribution, for example.

The above-mentioned sequence of processing operations may be executed by software as well as hardware.

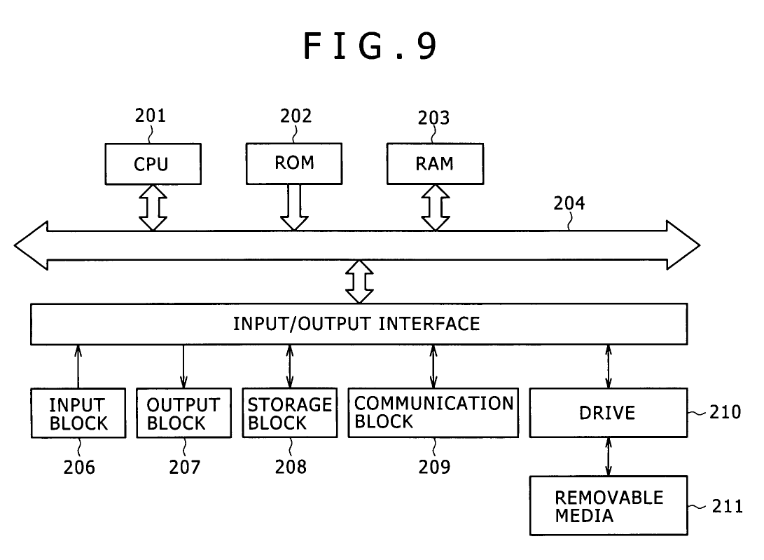

In this case, a personal computer shown in FIG. 9, for example, can be employed at least as a part of the above-mentioned information processing system.

Referring to FIG. 9, a CPU (Central Processing Unit) 201 executes various processing operations as instructed by programs stored in a ROM (Read Only Memory) 202 or programs loaded from a storage block 208 into a RAM (Random Access Memory) 203. The RAM 203 also stores, from time to time, data and so on that are necessary for the CPU 201 to execute various processing operations.

The CPU 201, the ROM 202, and the RAM 203 are interconnected via a bus 204. The bus 204 is also connected with an input/output interface 205.

The input/output interface 205 is connected with an input block 206 having a keyboard and a mouse, for example, an output block 207 having a display monitor for example, the storage block 208 based on a hard disk drive for example, and a communication block 209 having a modem and a terminal adaptor, for example. The communication block 209 controls communication with other apparatuses (not shown) via a network, such as the Internet.

The input/output interface 205 is also connected with a drive 210 as necessary, on which a removable media 211, such as a magnetic disk, an optical disk, a magneto-optical disk, or a semiconductor memory is loaded, computer programs read therefrom being installed in the storage block 208 as necessary.

When the above-mentioned sequence of processing operations is executed by software, the programs constituting the software are installed in a computer which is built in dedicated hardware equipment or installed, from a network or recording media, into a general-purpose personal computer for example in which various programs may be installed for the execution of various functions.

As shown in FIG. 9, these recording media containing programs are constituted by not merely a removable media (package media) 211 made up of the magnetic disk (including flexible disks), the optical disk (including CD-ROM (Compact Disk Read Only Memory) and DVD (Digital Versatile Disk)), the magneto-optical disk (including MD (Mini Disk) (trademark)), or the semiconductor memory which is distributed separately from the apparatus itself, but also the ROM 202 or the storage block 208 which stores programs and is provided to users as incorporated in the apparatus itself.

It should be noted herein that the steps for describing each program recorded in recording media include the processing operations which are executed concurrently or discretely as well as the processing operations which are sequentially executed in a time-dependent manner.

It should be understood by those skilled in the art that various modifications, combinations, sub-combinations and alterations may occur depending on design requirements and other factor in so far as they are within the scope of the appended claims or the equivalents thereof.

What is claimed is:

1. An information processing apparatus for executing control such that one of image data and audio data is made subject to reproduction and the other data made subject to accompanying reproduction to reproduce both said subject to reproduction and said subject to accompanying reproduction, comprising:
comparing means for unifying a form of a feature of said subject to reproduction and a form of a feature of said subject to accompanying reproduction and make a comparison between these features; and
selecting means for selecting, on the basis of a result of comparison made by said comparing means, said subject to accompanying reproduction for said subject to reproduction from candidates of at least one subject to accompanying reproduction.

2. The information processing apparatus according to claim 1, wherein said comparing means unifies said forms of features by converting one of said feature of said subject to reproduction and said feature of a candidate of at least one subject to accompanying reproduction into the other.

3. The information processing apparatus according to claim 1, further comprising:
analyzing means for analyzing said features of said image data and said audio data to create a database of results of analysis,
wherein said comparing means references said features of said subject to reproduction and said at least one subject to accompanying reproduction from said database.

4. The information processing apparatus according to claim 1, further comprising:
reproducing means for reproducing said subject to reproduction along with said subject to accompanying reproduction selected by said selecting means.

5. The information processing apparatus according to claim 4, further comprising:
evaluating means for, on the basis of an evaluation by a user for a result of reproduction by said reproducing means, making a database of preference information of said user,
wherein said comparing means uses said preference information accumulated in said database as a judgment element for a comparison between said feature of said subject to reproduction and said feature of said candidate of said at least one subject to accompanying reproduction.

6. An information processing method for an information processing apparatus for executing control such that one of image data and audio data is made subject to reproduction and the other data made subject to accompanying reproduction to reproduce both said subject to reproduction and said subject to accompanying reproduction, comprising the steps of:
unifying a form of a feature of said subject to reproduction and a form of a feature of said subject to accompanying reproduction and make a comparison between these features; and
selecting, on the basis of a result of comparison made in the comparing step, said subject to accompanying reproduction for said subject to reproduction from candidates of at least one subject to accompanying reproduction.

7. A program for making a computer execute control such that one of image data and audio data is made subject to reproduction and the other data made subject to accompanying reproduction to reproduce both said subject to reproduction and said subject to accompanying reproduction, comprising the steps of:
unifying a form of a feature of said subject to reproduction and a form of a feature of said subject to accompanying reproduction and make a comparison between these features; and
selecting, on the basis of a result of comparison made in the comparing step, said subject to accompanying reproduction for said subject to reproduction from candidates of at least one subject to accompanying reproduction.

8. An information processing apparatus for executing control such that one of image data and audio data is made subject to reproduction and the other data made subject to accompanying reproduction to reproduce both said subject to reproduction and said subject to accompanying reproduction, comprising:
a comparing section configured to unify a form of a feature of said subject to reproduction and a form of a feature of said subject to accompanying reproduction and make a comparison between these features; and
a selecting section configured to select, on the basis of a result of comparison made by said comparing section, said subject to accompanying reproduction for said subject to reproduction from candidates of at least one subject to accompanying reproduction.
